(19) United States
(12) Patent Application Publication
(10) Pub. No.: US 2011/0073200 A1
(43) Pub. Date: Mar. 31, 2011

(54) GAS REGULATOR WITH VALVE ASSEMBLIES

(75) Inventors: Duane Bruce Overvaag, Watertown, SD (US); Benjamin Fredrick Johnson, Watertown, SD (US); Jason James Thuringer, Watertown, SD (US); Brian Lee Pellish, Watertown, SD (US)

(73) Assignee: Illinois Tool Works Inc., Glenview, IL (US)

(21) Appl. No.: 12/838,306

(22) Filed: Jul. 16, 2010

Related U.S. Application Data
(60) Provisional application No. 61/245,932, filed on Sep. 25, 2009.

(51) Int. Cl. F16K 15/00; F16K 1/00

(52) U.S. Cl. 137/528; 251/318

(57) ABSTRACT

Embodiments of a gas regulator with a body having an inlet, an outlet, and a gas regulating assembly adapted to regulate output pressure of gas delivered to the outlet reduced from inlet pressure of the gas at the inlet are provided. In some embodiments, the gas regulating assembly may include a ball check assembly adapted to substantially reduce flow from the outlet to the inlet when a gas source is coupled to the outlet. The gas regulator may also include a positive flow shutoff valve assembly having a valve member disposed within the body and an adjustment disposed external to the body.

### CROSS REFERENCE TO RELATED APPLICATIONS

This application is a Non-Provisional patent application of U.S. Provisional Patent Application No. 61/245,932 entitled “Integral Regulator Valve”, filed Sep. 25, 2009, which is herein incorporated by reference.

### BACKGROUND

The invention relates generally to gas regulators, and, more particularly, to single stage and two stage specialty gas regulators.

Gas regulators are used in a variety of different industries and applications, such as chemical and biological laboratories, welding systems, recreational vehicles, residential and commercial buildings, and so forth. Gas regulators provide important functions in applications that require a flow of compressed air or specialty gases, such as nitrogen, oxygen, argon, helium, acetylene, and so forth, typically stored in high pressure vessels or tanks. In general, such gas regulators operate by reducing the pressure of the gas from a container (typically of highly compressed gas) to a desired level that may be adjusted manually and read on a gauge attached to the regulator. Such gas regulators traditionally include a variety of internal components (e.g., springs, plates, and washers), which cooperatively function to handle both normal operating demands and extreme circumstances.

A bonnet is traditionally used to contain the internal components inside the gas regulator. Such bonnets are typically made from a metal, such as brass or zinc, since the bonnets must be designed to withstand high pressures (e.g., 3000 PSI) during extreme instances of overpressurization (e.g., in case of failure of the regulating components). Metal bonnets are capable of withstanding high pressures while containing potentially broken internal components that may be produced during a failure event, and for dissipating the gas pressure in a controlled way. However, high monetary costs are often associated with the use of such metal bonnets. Accordingly, improved bonnets for gas regulators made of lighter, less expensive materials, such as 30% glass filled nylon, have been developed to reduce the monetary costs associated with metal bonnets. Unfortunately, such bonnets may have a reduced capacity to handle instances of overpressurization. For example, in common laboratory applications, an operator may mistakenly couple the high pressure gas cylinder to the outlet of the gas regulator, thus potentially causing failure of the bonnet.

Additionally, in some laboratory applications, high purity gas flows from storage cylinders to provide gas at acceptable levels for use in critical laboratory procedures, such as chromatography and blood analysis, which may be sensitive to contamination from atmospheric gases. Unfortunately, current gas regulators may be susceptible to such contamination, thus interfering with the quality of the results obtained via the laboratory procedures. Accordingly, there exists a need for improved gas regulators that address such drawbacks with conventional gas regulator assemblies.

### BRIEF DESCRIPTION

In an exemplary embodiment, a gas regulator includes a body having an inlet, an outlet, and a seating surface disposed in an interior of the body. The gas regulator also includes a gas regulating assembly disposed at least partially in the body and adapted to regulate output pressure of gas delivered to the outlet reduced from inlet pressure of the gas at the inlet by adjustment of the regulating assembly. The gas regulator also includes a positive flow shutoff valve assembly including an adjustment extending outside of the body and adapted to be adjusted by an operator and a valve member coupled to the adjustment and disposed within the body. The valve member is adapted to move toward or away from the seating surface disposed in the body as the adjustment is adjusted to shut off gas flow through the body.

In another embodiment, a gas regulator includes a body having an inlet and an outlet. The gas regulator also includes a gas regulating assembly integral with the body and adapted to regulate output pressure of gas delivered to the outlet reduced from inlet pressure of the gas at the inlet. The gas regulating assembly includes a ball check assembly configured to substantially reduce flow from the outlet to the inlet when a gas source is coupled to the outlet.

In another embodiment, a gas regulator includes a body including an inlet, an outlet, and a seating surface disposed in an interior of the body. The gas regulator also includes a gas regulating assembly disposed at least partially in the body and adapted to regulate output pressure of gas delivered to the outlet reduced from inlet pressure of the gas at the inlet. The gas regulating assembly includes a first valve assembly including a ball check apparatus adapted to substantially reduce flow from the outlet to the inlet when a gas source is coupled to the outlet. The gas regulator also includes a positive flow shutoff valve assembly including an adjustment extending outside of the body and adapted to be adjusted by an operator and a valve member coupled to the adjustment and disposed within the body. The valve member is adapted to move toward or away from the seating surface disposed in the body as the adjustment is adjusted to shut off gas flow through the body.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a perspective view of an exemplary single stage gas regulator in accordance with aspects of the present invention;

FIG. 2 is an exploded view of a gas regulating assembly of the exemplary single stage gas regulator of FIG. 1 in accordance with aspects of the present invention;

FIG. 3 is a perspective view of an exemplary ball check assembly in accordance with aspects of the present invention;

FIG. 4 is an exploded view of the exemplary single stage gas regulator of FIG. 1 in accordance with aspects of the present invention;

FIG. 5 is a cross sectional view of an exemplary single stage gas regulator taken along line 5-5 of FIG. 1.

FIG. 6 illustrates a perspective view of an exemplary two stage gas regulator in accordance with aspects of the present invention;

FIG. 7 is an exploded view of a gas regulating assembly of the exemplary two stage gas regulator of FIG. 6 in accordance with aspects of the present invention;

FIG. 8 is an exploded view of the exemplary two stage gas regulator of FIG. 6 in accordance with aspects of the present invention; and

FIG. 9 is a cross sectional view of an exemplary single stage gas regulator taken along line 9-9 of FIG. 6.

### DETAILED DESCRIPTION

As described in detail below, embodiments of a gas regulator including an integral valve assembly and a ball check assembly are provided. In one embodiment, the integral valve assembly is adapted to allow an operator to control an outlet gas flow by adjusting an adjustment, such as a knob located external to the gas regulator and coupled to a needle disposed within the gas regulator. The foregoing feature may offer distinct advantages over gas regulators including valve assemblies that are not integral with a body of the gas regulator. For example, embodiments of the integral valve assembly integrated into specialty gas regulators designed for use with high purity gases may reduce or eliminate the possibility of contamination of the specialty gas regulator with atmospheric gases.

Embodiments of the presently disclosed gas regulators may also include the ball check valve assembly. The ball check valve assembly is adapted to substantially reduce gas flow from the outlet to the inlet of a body of the gas regulator when a gas source is erroneously coupled to the outlet. That is, in instances in which the gas source (e.g., a gas cylinder) is mistakenly coupled to the outlet of the gas regulator, the ball check valve assembly may substantially prevent overpressurization of a bonnet of the gas regulator assembly. For example, in some embodiments, the ball check valve assembly may include a ball, a ball stop and a check plug. In such embodiments, the ball is adapted to be seated in the ball stop when the gas source is correctly coupled to the inlet, and flow is established from the inlet through one or more slots on the ball stop and to the outlet. However, when the gas source is incorrectly coupled to the outlet, the ball is adapted to be seated in the unslotted check plug, thus preventing gas from flowing to the bonnet. In such instances, by substantially disallowing flow from the outlet to the inlet, the ball check valve assembly may lead to the opening of a relief valve assembly and the subsequent venting of the gas to the surrounding environment.

It should be noted that embodiments of the integral valve assembly and the ball check valve assembly may be incorporated into any of a variety of suitable gas regulators, such as specialty gas regulators, single stage gas regulators, two stage gas regulators, and so forth. For example, the novel valve assemblies disclosed herein may be employed in the context of single stage gas regulators adapted to receive a gas from a gas source and to regulate an inlet gas pressure of the gas to an outlet gas pressure in a single step. Moreover, the disclosed valve assemblies may also be utilized in two stage gas regulators adapted to regulate an inlet pressure to an outlet pressure in two steps. Indeed, the novel valve assemblies described herein may be utilized in any gas regulator designed to regulate a pressure of an incoming gas to a suitable output pressure.

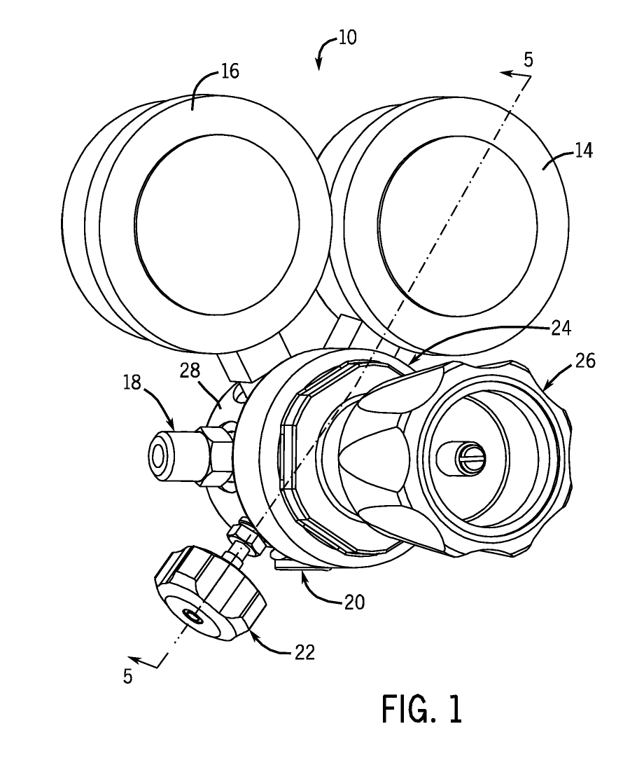

Turning now to the drawings, FIG. 1 illustrates a perspective view of an exemplary single stage gas regulator assembly 10, which is adapted to be attached to a gas source (e.g., a gas cylinder) via a suitable fixture. The gas regulator assembly 10 includes an inlet gauge 14, an outlet gauge 16, an outlet 18, an inlet (not shown), a relief valve assembly 20, an integral valve assembly 22, a bonnet 24, an adjusting knob 26, and a body 28. During operation, the single stage gas regulator assembly 10 is adapted to receive gas at an inlet pressure and to generate output gas pressure from inlet gas pressure in one step. As such, the knob 26 and the integral valve assembly 22 may be adapted to allow an operator to control the pressure and flow of the gas at the outlet. During use, as the operator adjusts the knob 26, gas flows from the gas cylinder into the body 28 of the gas regulator assembly 10 via the inlet, and the inlet gauge 14 indicates a measurement of the pressure at the inlet. The gas is routed through internal passages of the body 28, which are configured to regulate the pressure of the gas. For example, a gas regulating assembly disposed within the body 28 may receive incoming gas from the gas cylinder at a high pressure and regulate the gas pressure to a lower pressure suitable for use in a downstream application (e.g., a laboratory experiment, hospital or medical application, welding or cutting operation, etc.) at the outlet. As such, during use, the outlet gauge 16 indicates a measurement of the pressure at the outlet of the gas regulator assembly 10.

During operation, the relief valve assembly 20 allows pressurized gas to flow out of the gas regulator assembly 10 when the pressure exceeds a predetermined limit. That is, the relief valve assembly 20 may function to vent the gas to the surrounding environment during instances of overpressurization. As such, the relief valve assembly 20 may include a variety of suitable components, such as a seat, a seat retainer, a spring, a relief valve body, and so forth.

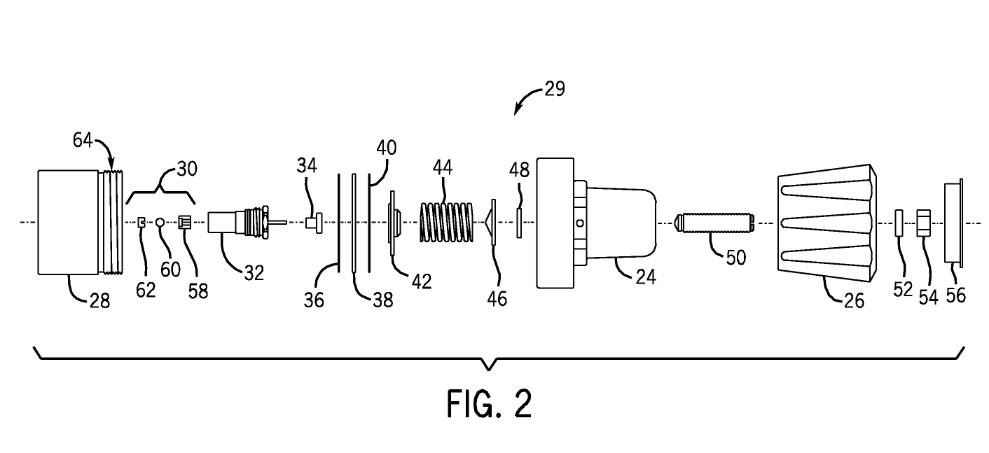

FIG. 2 is an exploded view of the single stage gas regulator assembly 10 of FIG. 1 illustrating an exemplary gas regulating assembly 29. As illustrated, the components of the single stage gas regulating assembly 29 include the body 28, a ball check assembly 30, a seat assembly 32, a stem support 34, an o-ring 36, a diaphragm 38, a diaphragm washer 40, a backup plate 42, an adjusting spring 44, a spring button 46, a push nut 48, the bonnet 24, an adjusting screw 50, the knob 26, a lock washer 52, a nut 54, and a hole plug 56. In the illustrated embodiment, the ball check assembly 30 includes a check plug 58, a ball 60, and a ball stop 62.

When assembled, the hole plug 56, the nut 54 and the lock washer 52 are threaded onto adjusting screw 50 through an axial interior channel of the knob 26, which is secured to the bonnet 24 during use. The bonnet 24 is threaded onto the body 28 via threads 64 to form a protective housing for components 58, 60, 62, 32, 34, 36, 38, 40, 42, 44, 46, and 48. The body 28 is manufactured such that an internal path exists for the flow of gas through the body 28. During operation, as the adjusting screw 50 is threaded into the bonnet 24, the spring 44 becomes compressed between the spring button 46 and the backup plate 42, thus increasing the gas force that must be applied downstream to oppose the spring force. Similarly, as the adjusting screw 50 is threaded out of the bonnet 24, the spring 44 expands, thus decreasing the gas force that must be applied downstream to oppose the spring force. Accordingly, an operator may adjust the gas pressure via rotation of the knob 26 coupled to the adjusting screw 50.

The single stage gas regulator assembly 29 further includes the spring button 46, which is used to direct the movement of the spring 44 during its compression and expansion. The spring 44 is elastically deformed during compression, thus generating a variable and controllable force that determines the selected outlet (i.e., regulated) pressure. The spring 44 includes a central opening that is configured to sit on the backup plate 42, which centers the spring 44 in the gas regulating assembly 10 and may be adapted to allow pressure to be applied to the diaphragm 38. The diaphragm washer 40 is provided to substantially prevent the diaphragm 38 from bunching during assembly. In some embodiments, the diaphragm 38 may be made of reinforced rubber.

In some embodiments, the bonnet 24 may be made of a moldable synthetic plastic material. For instance, in one embodiment, the bonnet 24 may be made of 30% glass filled nylon. This feature may have the effect of reducing the monetary cost of the single stage gas regulator assembly 10 as compared to traditional systems, which may include bonnets made of metals, such as brass or zinc. However, since such moldable synthetic plastic bonnets may not be capable of withstanding pressure levels that may be contained within metal bonnets, embodiments of the present invention may include one or more features or modifications that substantially reduce or eliminate the possibility of overpressurization of the bonnet 24. It should be noted, however, that such modifications to the gas regulator assembly 10 may be employed in conjunction with bonnets made of any suitable material, such as a moldable synthetic plastic, a metal, and so forth.

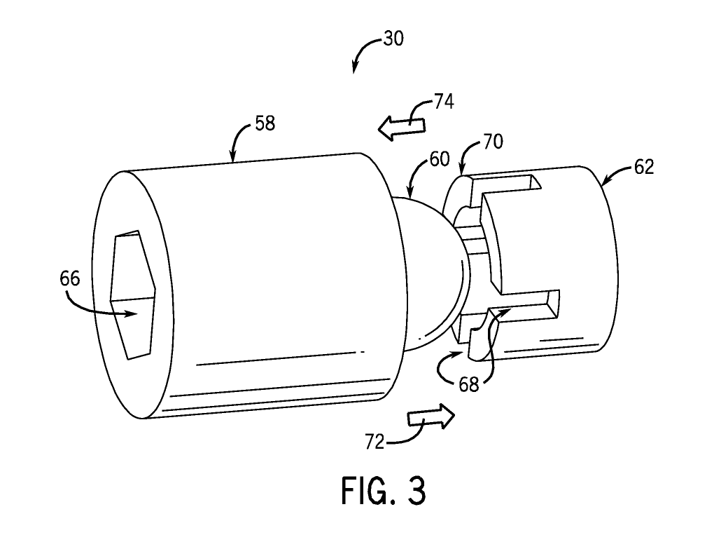

One such feature that the single stage gas regulator 29 may include in certain embodiments is the ball check assembly 30. FIG. 3 illustrates an exemplary ball check assembly 30 in more detail. As shown, the ball check assembly 30 includes the ball stop 62, the ball 60, and the check plug 58. The check plug 58 includes an internal channel 66 extending axially therethrough. The ball stop 62 includes one or more slots 68 and one or more protrusions 70. When not in use, the ball 60 is adapted to remain freely suspended between the ball stop 62 and the check plug 58.

During normal operation of the gas regulator assembly 10, gas flow is established from the inlet to the outlet in a direction indicated by arrow 72. The flow 72 pushes the ball 60 toward the ball stop 62, and the ball 60 becomes seated in the ball stop 62 while gas is flowing toward and exiting out of the outlet. The flow 72 is established from the inlet, through the passage 66 in the check plug 58, around the ball 60 and through the slots 68 in the ball stop 62. That is, the slots 68 in the ball stop 62 allow gas to reach the outlet even while the ball 60 is seated in the ball stop 62. However, if flow is established from the outlet toward the inlet, as indicated by arrow 74, the ball check assembly 30 is adapted to substantially prevent flow through the channel 66 in the direction of arrow 74. For example, if a user mistakenly connects the gas cylinder to the outlet of the gas regulator assembly 10, high pressure gas is substantially prevented from reaching the bonnet 24. Specifically, if flow is established in the direction of arrow 74, the ball 60 is pushed toward the check plug 58 and becomes seated in the check plug 58, thus blocking channel 66.

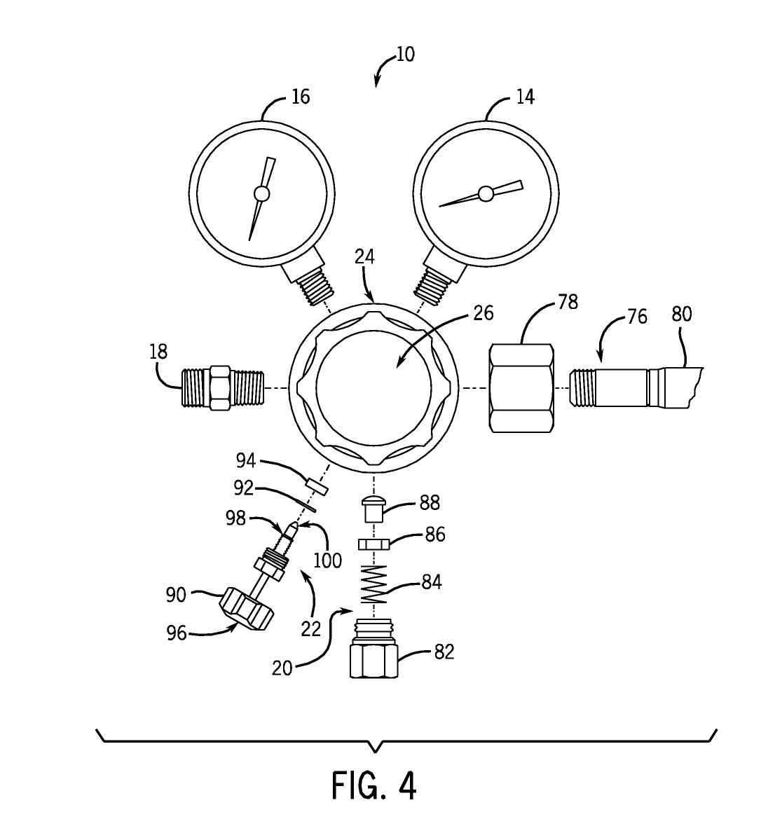

FIG. 4 is an exploded view of the single stage gas regulator assembly 10 of FIG. 1. The exploded view includes the inlet gauge 14, the outlet gauge 16, the outlet 18, an inlet 76, the relief valve assembly 20, the integral valve assembly 22, and the knob 26 coupled to the bonnet 24. The inlet 76 includes a nut 78 adapted to connect to the body 28 of the regulator assembly 10 and further includes a tailpiece 80 adapted to couple directly to the gas cylinder or to a connector coupled to the gas cylinder. The relief valve assembly 20 includes a relief valve body 82, a spring 84, a seat retainer 86, and a seat 88. The integral valve assembly 22 includes a main assembly 90, a washer 92, and packing 94. The main assembly 90 includes a knob 96 and a needle 98 terminating in a tip 100. Embodiments of the present invention include the knob 96 disposed outside of the body 28 of the regulator and the needle 98 terminating in the tip 100 integral with the body 28 during use as described in detail below. However, it should be noted that in further embodiments, the inlet 76, the outlet 18, the integral valve assembly 22, and the relief valve assembly 20 may include more or fewer components than those illustrated in FIG. 4.

During normal operation, gas enters the single stage pressure regulator assembly 10 from the gas cylinder through the tailpiece 80 of the inlet 76. The gas is then routed through the gas regulating assembly in the body 28. The gas regulating assembly is adapted to regulate output pressure of the gas delivered to the outlet 18 reduced from the inlet pressure of the gas at the inlet 76. The knobs 26 and 96 may be utilized by the operator to determine the level of the regulated outlet pressure of the gas. As described in detail below, the relief valve assembly 20 cooperates with the ball check assembly 30 to ensure release of pressure in instances of overpressurization.

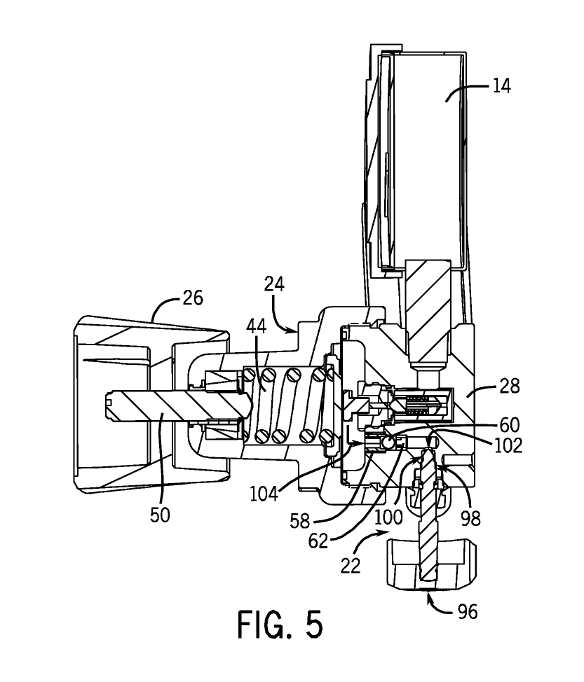

FIG. 5 is a cross sectional view of the exemplary single stage gas regulator taken along line 5-5 of FIG. 1. As shown, the integral valve assembly 22 includes the knob 96 and the needle 98 terminating in the tip 100. In the illustrated embodiment, the knob 96 is disposed outside the body 28 to remain accessible to the operator for control of outlet gas flow. However, the needle 98 terminating in the tip 100 is integral with the body 28. The tip 100 of the needle is adapted to be received by a seating surface 102 disposed within the body 28. During operation, as the knob 96 position is adjusted by the operator, the needle 98 is configured to move toward or away from the seating surface 102 to control the outlet gas flow. For example, when the tip 100 of the needle 98 is seated flush against seating surface 102, a compressive force substantially prevents gas leakage.

During use, the check valve assembly is adapted to substantially prevent overpressurization of the bonnet 24 during instances of incorrect flow, as described in detail above. For example, in the illustrated embodiment, normal flow is established in the direction from the inlet to the outlet, as indicated by arrow 104. During such flow, the ball 60 is seated against ball stop 62 and gas flows through slots 68 toward the outlet. However, during abnormal flow, such as when an operator mistakenly connects the gas source to the outlet, flow forces the ball 60 to rest in the check plug 58, thus substantially preventing flow into the bonnet 24. Such a mechanism may allow the relief valve assembly 20 adequate time to open and release the high pressure gas before damage may be caused to the bonnet 24 due to extreme pressure conditions (e.g., 3000 PSI).

During operation, the single stage gas regulator 10 is adapted to receive gas at an inlet pressure and to generate output gas pressure from the inlet gas pressure in one step. Since the inlet pressure of the gas from the gas source directly determines the spring force on the diaphragm (i.e., the spring force on the diaphragm approximately equals the opposing force of the gas), the single stage gas regulator 10 may be susceptible to changes in the outlet gas pressure over time. For example, in embodiments in which the gas source is a gas cylinder, as the cylinder pressure decreases over time, the regulated pressure will increase. In such instances, the knob 26 may need to be periodically adjusted if a constant output pressure is desired. Accordingly, in some embodiments, it may be desirable to employ a two-stage gas regulator, as described in detail below.

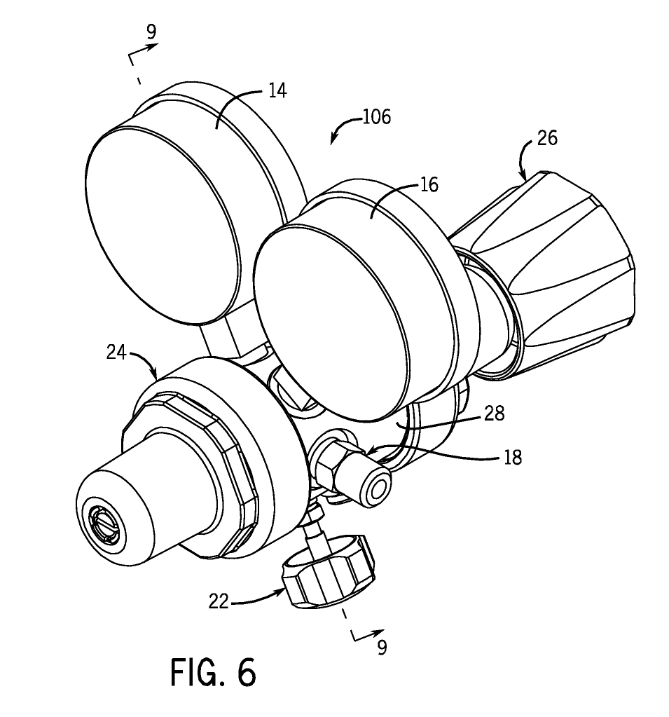

FIG. 6 is a perspective view of an exemplary two stage gas regulator assembly 106, which may be attached to a gas cylinder via a suitable fixture. The two stage gas regulator assembly 106 may obviate some of the drawbacks associated with embodiments of the single stage gas regulator 10. For instance, the two stage gas regulator 106 may include a first stage that is adapted to generate an intermediate gas pressure from the inlet gas pressure and a second stage that is adapted to generate the outlet gas pressure from the intermediate gas pressure. That is, the two stage regulator 106 may be adapted to function as two single stage gas regulators operating in series, the first stage reducing the inlet pressure to an intermediate level and the second stage reducing the intermediate level even further to the output level set by the operator. As such, the intermediate pressure generated by the first stage may be susceptible to decreases in cylinder pressure, but the output pressure remains constant since the intermediate pressure is further regulated to the output pressure via the second stage. Accordingly, embodiments of the two stage regulator 106 may substantially reduce or eliminate the need for the operator to readjust the knob 26 to maintain a constant output pressure.

Turning now to the illustrated components of FIG. 6, the two-stage gas regulator assembly 106 includes the outlet gauge 16, the inlet gauge 14, the outlet 18, the inlet (not shown), the relief valve assembly 20, a second relief valve assembly (not shown), the integral valve assembly 22, the bonnet 24, the adjusting knob 26, and the body 28. During operation, the two stage gas regulator assembly 106 is adapted to receive gas at an inlet pressure and to generate output gas pressure from inlet gas pressure in two steps. As such, the knob 26 and the integral valve assembly 22 may be adapted to allow an operator to control the pressure and flow of the gas at the outlet. During use, as the operator adjusts the knob 26, gas flows from the gas cylinder into the body 28 of the gas regulator assembly 106 via the inlet 76, and the inlet gauge 14 indicates a measurement of the pressure at the inlet 76. The gas is routed through internal passages of the body 28, which are configured to regulate the pressure of the gas in two steps. For example, a gas regulating assembly disposed within the body 28 may receive incoming gas from the gas cylinder at a high pressure and regulate the gas pressure to a preset intermediate pressure in the first stage. The gas regulating assembly may further regulate the intermediate pressure in the second stage to an even lower pressure suitable for use in a downstream application at the outlet. As before, during use, the outlet gauge 16 indicates a measurement of the pressure at the outlet of the gas regulator assembly 106.

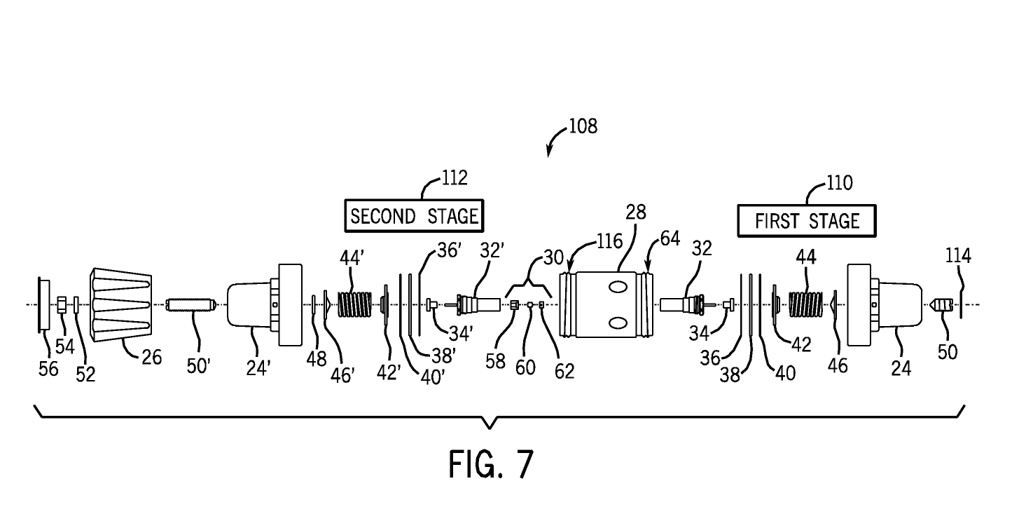

FIG. 7 is an exploded view of the two stage gas regulator assembly 106 of FIG. 6 illustrating an exemplary gas regulating assembly 108. As shown, the gas regulating assembly 108 includes a first stage 110 and a second stage 112. The components of the first stage 110 disposed on the right side of the body 28 in the illustrated view include the seat assembly 32, the stem support 34, the o-ring 36, the diaphragm 38, the diaphragm washer 40, the backup plate 42, the spring 44, the spring button 46, the bonnet 24, the adjusting screw 50, and a decal 114. Similarly, the components of the second stage 112 disposed on the left side of the body 28 in the illustrated view include the ball check assembly 30, a seat assembly 32′, a stem support 34′, an o-ring 36′, a diaphragm 38′, a diaphragm washer 38′, a backup plate 42′, a spring 44′, a spring button 46′, the push nut 48, a bonnet 24′, an adjusting screw 50′, the knob 26, the lock washer 52, the nut 54, and the hole plug 56.

When assembled, the hole plug 56, the nut 54 and the lock washer 52 are threaded onto adjusting screw 50′ through an axial interior channel of the knob 26, which is secured to the bonnet 24′ during use. The bonnet 24′ is threaded onto the body 28 via threads 116 to form a protective housing for components 58, 60, 62, 32′, 34′, 36′, 38′, 40′, 42′, 44′, 46′, and 48′. Likewise, the decal 114 covers adjusting screw 50. The bonnet 24 is threaded onto the body 28 via threads 64 to form a protective housing for components 32, 34, 36, 38, 40, 42, 44, and 46.

During operation, incoming gas flow is first directed into the first stage 110 to regulate the incoming pressure to a preset intermediate pressure. Compression and expansion of the spring 44 between the spring button 46 and the backup plate 42 generates a controllable force that determines the selected intermediate pressure. As with the single stage design, the spring 44 includes a central opening that is configured to sit on the backup plate 42, which centers the spring 44 in the gas regulating assembly and may be adapted to allow pressure to be applied to the diaphragm 38. The diaphragm washer 40 is provided to substantially prevent the diaphragm 38 from bunching during assembly.

Once reduced to the intermediate pressure, the gas flow enters the second stage 112 where the pressure is regulated to the desired output pressure. Specifically, as the adjusting screw 50′ is threaded into the bonnet 24′, the spring 44′ becomes compressed between the spring button 46′ and the backup plate 42′, thus increasing the gas force that must be applied downstream to oppose the spring force. Similarly, as the adjusting screw 50′ is threaded out of the bonnet 24′, the spring 44′ expands, thus decreasing the gas force that must be applied downstream to oppose the spring force. Accordingly, an operator may adjust the gas pressure via rotation of the knob 26 coupled to the adjusting screw 50′.

The second stage 112 also includes the ball check assembly 30 including the check plug 58, the ball 60, and the ball stop 62. As before, the ball check assembly 30 may be adapted to substantially reduce flow from the outlet to the inlet when a gas source is mistakenly coupled to the outlet. That is, the ball 60 may be adapted to seat against the ball stop during normal operation, thus allowing flow from the inlet to reach the outlet. However, during instances in which flow originates from the outlet, the ball 60 may be adapted to seat against the check plug 58, thus substantially preventing flow toward the bonnet 24′.

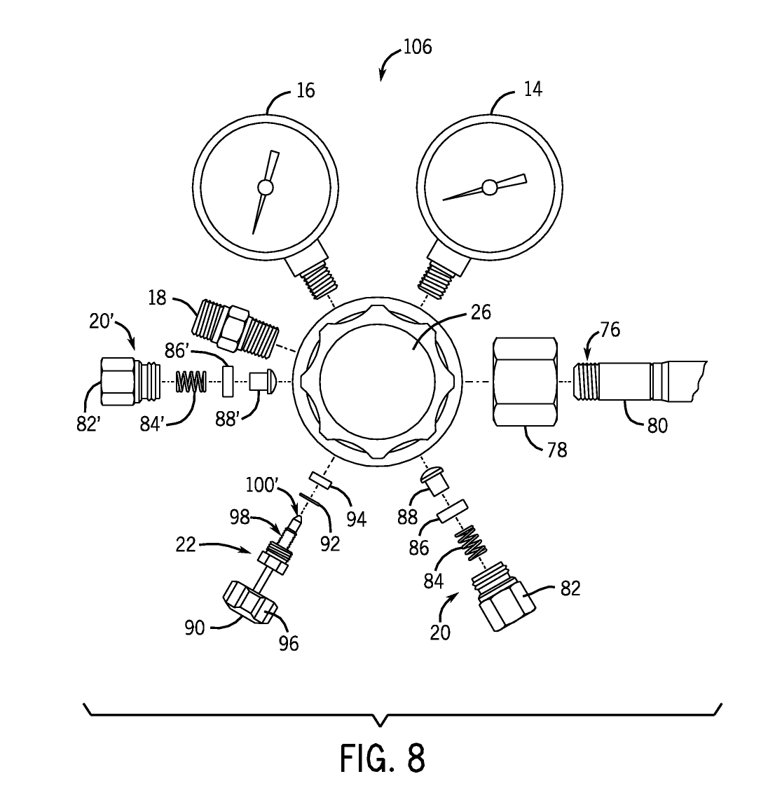

FIG. 8 is an exploded view of the two stage gas regulator assembly 106 of FIG. 6. The exploded view includes the inlet gauge 14, the outlet gauge 16, the inlet 76, the outlet 18, the first relief valve assembly 20, a second relief valve assembly 20′, the integral valve assembly 22, and the knob 26. As before, the first relief valve assembly 20 includes the relief valve body 82, the spring 84, the seat retainer 86, and the seat 88. Similarly, the second relief valve assembly 20′ includes a relief valve body 82′, a spring 84′, a seat retainer 86′, and a seat 88′. As before, the integral valve assembly 22 includes the main assembly 90, the washer 92, and the packing 94. The main assembly 90 includes the knob 96 and the needle 98 terminating in the tip 100. As with the single stage design, embodiments of the two stage design also include the knob 96 disposed outside of the body 28 of the regulator and the needle 98 terminating in the tip 100 integral with the body 28. The foregoing feature of the two-stage gas regulator 106 may have the effect of maintaining the purity of the inlet gas by preventing leakage into or out of the regulator body when the tip 100 of the needle 98 is seated on the seating surface 102 within the body.

During normal operation, gas enters the two stage pressure regulator assembly 106 from the gas cylinder through the tailpiece 80 of the inlet 76. The gas is then routed through the gas regulating assembly in the body 28. The gas regulating assembly is adapted to regulate output pressure of the gas delivered to the outlet 18 reduced from the inlet pressure of the gas at the inlet 76 in two steps. As described in detail below, the first relief valve assembly 20 and the second relief valve assembly 20′ cooperate with the ball check assembly 30 to ensure release of pressure from the first stage 110 and the second stage 112 in instances of overpressurization.

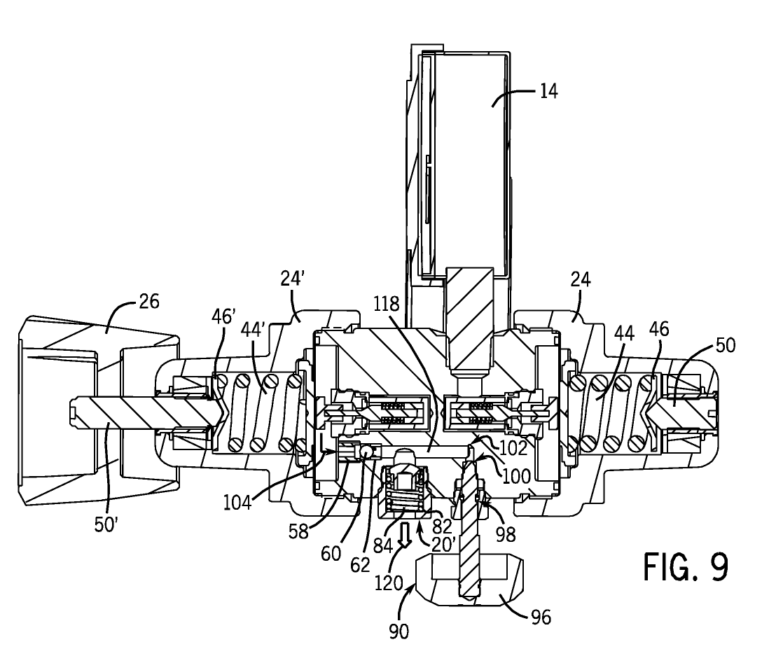

FIG. 9 is a cross sectional view of the exemplary two stage gas regulator taken along line 9-9 of FIG. 6. As shown, the integral valve assembly 22 includes the knob 96 and the needle 98 terminating in the tip 100. The knob 96 is disposed outside the body 28 to remain accessible to the operator during use while the needle 98 terminating in the tip 100 is integral with the body 28. The tip 100 of the needle is adapted to be received by the seating surface 102 disposed within the body 28. As before, when the tip 100 of the needle 98 is seated flush against seating surface 102, a compressive force substantially prevents gas leakage to or from the surrounding atmosphere.

During use, the check valve assembly is adapted to substantially prevent overpressurization of the bonnets 24 and 24′ during instances of incorrect flow, as described in detail above. For example, in the illustrated embodiment, normal flow is established in the direction from the inlet to the outlet, as indicated by arrow 104. During such flow, the ball 60 is seated against ball stop 62 and gas flows through slots 68 toward the outlet. During abnormal flow, such as when an operator mistakenly connects the gas source to the outlet, gas forces the ball 60 to rest in the check plug 58, thus substantially preventing flow into the bonnet 24′. When the gas is substantially prevented from flowing in a direction opposite arrow 104, the pressure inside chamber 118 builds, and the relief valve assembly 20 opens, thus venting the high pressure gas to the atmosphere, as indicated by arrow 120. As such, the ball check assembly 30 may react first to the improper flow path, thus allowing the relief valve assembly 20 adequate time to open and release the high pressure gas before damage may be caused to the bonnet 24′ due to extreme pressure conditions.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A gas regulator, comprising:
a body comprising an inlet, an outlet, and a seating surface disposed in an interior of the body; and
a gas regulating assembly disposed at least partially in the body and configured to regulate output pressure of gas delivered to the outlet reduced from inlet pressure of the gas at the inlet by adjustment of the regulating assembly; and
a positive flow shutoff valve assembly comprising an adjustment extending outside of the body and configured to be adjusted by an operator, and a valve member coupled to the adjustment and disposed within the body, wherein the valve member is configured to move toward or away from the seating surface disposed in the body as the adjustment is adjusted to shut off gas flow through the body.

2. The gas regulator of claim 1, wherein the gas regulating assembly further comprises a ball check assembly configured to substantially reduce pressure on a bonnet of the gas regulating assembly when an inlet gas source is coupled to the outlet of the body.

3. The gas regulator of claim 2, wherein the ball check assembly comprises a ball, a check plug, and a ball stop having one or more slots.

4. The gas regulator of claim 3, wherein the ball is configured to be seated in the ball stop while gas is flowing from the inlet to the outlet through the one or more slots of the ball stop and to be seated in the check plug while gas is flowing from the outlet toward the inlet.

5. The gas regulator of claim 4, further comprising a relief valve assembly disposed in the body and configured to facilitate flow out of the body when the ball is seated in the check plug.

6. The gas regulator of claim 1, further comprising a bonnet coupled to the body over the gas regulating assembly, wherein the bonnet is made of a moldable synthetic plastic material.

7. The gas regulator of claim 6, wherein the bonnet is made of glass reinforced nylon.

8. The gas regulator of claim 1, wherein the gas regulating assembly is a single stage regulator configured to generate output gas pressure from inlet gas pressure in one step.

9. The gas regulator of claim 1, wherein the gas regulating assembly is a two stage regulator, wherein a first stage is configured to generate an intermediate gas pressure from inlet gas pressure and a second stage is configured to generate outlet gas pressure from the intermediate gas pressure.

10. A gas regulator, comprising:
a body comprising an inlet and an outlet; and
a gas regulating assembly disposed at least partially in the body and configured to regulate output pressure of gas delivered to the outlet reduced from inlet pressure of the gas at the inlet, wherein the gas regulating assembly comprises a ball check assembly configured to substantially reduce flow from the outlet to the inlet when a gas source is coupled to the outlet.

11. The gas regulator of claim 10, wherein the ball check assembly comprises:
a check plug coupled to the body;
a ball stop having one or more slots; and
a ball configured to be seated in the ball stop while gas is flowing from the inlet to the outlet through the one or more slots of the ball stop and to be seated in the check plug while gas is flowing from the outlet toward the inlet.

12. The gas regulator of claim 11, wherein the gas regulating assembly further comprises a relief valve assembly configured to facilitate unidirectional flow out of the body while the ball is seated in the check plug.

13. The gas regulator of claim 10, further comprising a bonnet coupled to the body over the gas regulating assembly, wherein the bonnet is made of a moldable synthetic plastic material.

14. The gas regulator of claim 13, wherein the bonnet is made of glass reinforced nylon.

15. The gas regulator of claim 10, wherein the gas regulating assembly further comprises a positive flow shutoff valve assembly configured to shut off gas flow through the body.

16. The gas regulator of claim 15, wherein the positive flow shutoff valve assembly valve assembly comprises a needle valve assembly comprising a knob extending outside of the body and configured to be adjusted by an operator and a needle coupled to the knob and disposed within the body, wherein the needle is configured to move toward or away from a seating surface disposed in the body as the adjustment is adjusted to shut off gas flow through the body.

17. The gas regulator of claim 10, wherein the gas regulating assembly is a two stage regulator configured to generate output gas pressure from inlet gas pressure in two steps.

18. A gas regulator, comprising:
a body comprising an inlet, an outlet, and a seating surface disposed in an interior of the body;
a gas regulating assembly disposed at least partially in the body and configured to regulate output pressure of gas delivered to the outlet reduced from inlet pressure of the gas at the inlet, wherein the gas regulating assembly comprises:
a first valve assembly comprising a ball check apparatus configured to substantially reduce flow from the outlet to the inlet when a gas source is coupled to the outlet; and
a positive flow shutoff valve assembly comprising an adjustment extending outside of the body and configured to be adjusted by an operator, and a valve member coupled to the adjustment and disposed within the body, wherein the valve member is configured to move toward or away from the seating surface disposed in the body as the adjustment is adjusted to shut off gas flow through the body.

19. The gas regulator of claim 18, wherein the ball check apparatus comprises a check plug coupled to the body, a ball stop, and a ball configured to be seated in the ball stop while gas is flowing from the inlet to the outlet and to be seated in the check plug while gas is flowing from the outlet toward the inlet.

20. The gas regulator of claim 19, wherein the gas regulating assembly further comprises a second valve assembly configured to facilitate unidirectional flow out of the body to release pressure inside the body while the ball is seated in the check plug.
